(19) United States
(12) Patent Application Publication
(10) Pub. No.: US 2007/0185831 A1
(43) Pub. Date: Aug. 9, 2007

(54) Information retrieval

(75) Inventor: Gavin Edward Churcher, Ipswich (GB)

Correspondence Address: NIXON & VANDERHYE, PC, 901 NORTH GLEBE ROAD, 11TH FLOOR, ARLINGTON, VA, 22203, US

(73) Assignee: British Telecommunications Public Limited Company, London (GB)

(21) Appl. No.: 10/593,422

(22) PCT Filed: Mar. 9, 2005
(86) PCT No.: PCT/GB05/00893

§ 371 Date: Sep. 19, 2006

(30) Foreign Application Priority Data
Mar. 31, 2004 (GB) 0407389.6

(51) Int. Cl. G06F 17/30

(52) U.S. Cl. 707/3

(57) ABSTRACT

An information retrieval system, and a method of operating an information retrieval system for retrieving information from a database in response to related queries submitted by a user, wherein information relating to possible interpretations of previous queries is stored and updated such that it may be used in order to disambiguate subsequent related queries and terms therein.

### TECHNICAL FIELD

The present invention relates to the field of information retrieval, and in particular to computer-based information retrieval, by virtue of which information, generally in the form of documents, may be retrieved from where it is stored in response to queries submitted by a user. It is applicable to the retrieval of information from structured databases, but is of particular use in relation to the retrieval of information from unstructured databases such as intranets or the Internet. More specifically, the present invention relates to information retrieval in situations where a user may submit queries that may relate to the same or similar fields of information as each other.

### BACKGROUND TO THE INVENTION AND PRIOR-ART

The techniques described below make use of Lexical Chains, which exist in the public domain, in order to provide improvements to techniques for information retrieval.

Lexical Chains

Lexical Chains are collections of semantic concepts that are grouped through similarity determined by one of a number of algorithms. The semantic concepts themselves may be represented by individual words, or groups of words such as expressions or sentences, or in other ways. The chosen algorithm may determine the semantics or meaning of a text by relating concepts that are linked through predetermined paths that exist in a conceptual ontology. Typically, the meaning of a word is ambiguous, but by considering other words in the surrounding text, the intended meaning can often be disambiguated. There are a number of algorithms in the literature which aim to derive the overall meaning of a text or collection of meanings by traversing paths through an ontology such as WordNet (see “Introduction to WordNet: An on-line lexical database” by George Miller, Richard Beckwith, Christiane Fellbaum, Derek Gross and Katherine Miller, International Journal of Lexicography (special issue) 3(4): 235-312, 1990). Senses or specific meanings in the WordNet database are represented relationally by synonym sets—which are sets of all the words sharing a common sense. To take an example, the word computer is represented by two sets: {calculator, reckoner, estimator, computer}—i.e. referring to a person who computes, and {computer, data processor, . . . }. By 1997, WordNet already contained more than 118,000 different word forms and newer versions continually extend the database. An algorithm for Lexical Chaining was presented by Hirst and St-Onge (see “Lexical chains as representations of context for the detection and correction of malapropisms”, Graeme Hirst and David St-Onge, in “WordNet: An electronic lexical database and some of its applications”, edited by C. Felibaum, Cambridge, MA: The MIT Press, 1997). This can be simplified as follows:
1. Select a set of candidate words, for example all words that appear as noun entries in WordNet.
2. For each candidate word, find an appropriate chain relaying on a relatedness criterion among members of the chains. Relatedness can be given as the distance from one word sense to another and the path it takes.
3. If found, insert the word into the chain and update accordingly.

In explaining their algorithm, Hirst and St-Onge use a definition of a lexical chain as “...in essence, a cohesive chain in which the criterion for inclusion of a word is that it bear some kind of cohesive relationship (not necessarily one specific relationship) to a word that is already in the chain”. They explain the need to be precise in specifying what counts as a “cohesive relationship” between words, and what counts as “general association of ideas”, and put forward the idea of using an earlier suggestion that a thesaurus, such as “Roget's International Thesaurus” (Editor: Robert L. Chapman, Fifth Edition, New York, 1992) could be used to define this. According to this suggestion, two words could be considered to be related if they are “connected” in the thesaurus in one (or more) of five possible ways:
1. Their index entries point to the same thesaurus category, or point to adjacent categories.
2. The index entry of one contains the other.
3. The index entry of one points to a thesaurus category that contains the other.
4. The index entry of one points to a thesaurus category that in turn contains a pointer to a category pointed to by the index entry of the other.
5. The index entries of each point to thesaurus categories that in turn contain a pointer to the same category.

This type of algorithm leads however to a “greedy” disambiguation strategy that has severe limitations. For example, in the following sentence this strategy would result in the incorrect disambiguation of the word ‘machine’, placing it in the chain with ‘person’ etc. The numbers that appear in superscript next to a word indicate that that word belongs to that chain.

Mr.¹ Kenny is the person¹ that invented an anaesthetic machine¹ which uses micro-computers² to control the rate at which an anaesthetic is pumped into the blood.

The explanation for this is that when the word ‘machine’ is processed, it is found to be related to the chain because ‘machine’ in one WordNet sense (“an efficient person”) is a holonym of ‘person’ in the chosen sense, and the words ‘machine’ and ‘person’ are thus related by what is termed a strong relation.

Other algorithms, for example that proposed by Barzilay and Elhadad (see “Using Lexical Chains for Text Summarization”, Regina Barzilay and Michael Elhadad, in Proceedings of the Intelligent Scalable Text Summarization Workshop (ISTS'97), ACL, Madrid, Spain, 1997), suggest a “non-greedy” approach that is more accurate in disambiguating words (i.e. assigning them to the correct Lexical Chain) with a trade-off in the amount of memory required to encode and maintain the Lexical Chains. The algorithm proposed by Barzilay differs from Hirst's mostly in its implementation of step 3 of the simplified algorithm outlined above. Effectively, each time a sense is added to a Lexical Chain, a duplicate of the original is kept, thus allowing multiple word senses to exist. Lexical Chains are formed in mutually exclusive sets and once processing is completed, the set with the strongest number of chains as determined by a weighting function is chosen as the overall interpretation of the text.

As will be explained later, an algorithm such as that proposed by Barzilay is one of a number that may be used for the main Lexical Chaining algorithm to be employed in embodiments of this invention: it maintains multiple hypotheses that are amenable to being updated progressively, and is therefore particularly suitable.

(b) Information Retrieval Techniques

Information Retrieval (IR) is the process of finding information that meets some criteria, such as containing keywords that have been specified by the user. Typically, a retrieval engine works by using an index that relates certain keywords, or their stemmed or derived equivalents, to the documents in which they occur. The engine then uses either a Boolean or ranking method to determine the relevance of documents covered in its index. A good introduction to the storage, indexing and retrieval of documents is given in the book “Managing Gigabytes: Compressing and Indexing Documents and Images” by Ian H Witten, Alistair Moffat and Timothy C. Bell (Second Edition, Morgan Kaufmann, 1999). Embodiments of the present invention draw on techniques such as those in the literature relating to information retrieval, in particular the concept of indexing terms and ranking using standard TFxIDF (Term Frequency and Inverse Document Frequency) methods.

Embodiments of the present invention aim to improve the precision accuracy of information retrieval systems where the user submits two or more queries, and in particular where the user submits several possibly consecutive queries that cover the same or similarly related semantic concepts.

Currently, most of the successful information retrieval systems available on the web, such as Google, for example, are keyword retrieval systems that employ ranking mechanisms. Typically, a user is able to specify a set of keywords for a search and may also be able to refine the results of an existing search by supplying further keywords. The second or subsequent set of keywords then becomes a search within the scope of the previously retrieved set. The problem with these types of retrieval engines is evident. Whilst Google is often very good at finding pages that are popularly related to the keywords, often several thousand documents are returned. The large number of documents is a product of the sheer quantity of documents on the web, and the ambiguity present in the keywords. Anecdotally, documents are included which have nothing to do with the area of interest, but are included because of this ambiguity. Information retrieval has two measures of accuracy: recall and precision. A high recall accuracy is often obtained by engines such as Google—all documents containing a keyword are returned—and it is their ranking methods that lead to their usefulness. However, often more important to a user is the precision accuracy—that is, the proportion of documents returned that are specifically relevant to the user.

Traditional information retrieval systems generally do not take into account consecutive searches that occur within a single domain about similar concepts. The user is currently faced with options either to conduct a new—and to the system—unrelated search, or to provide a new search that uses the current subset of documents. In both cases, keywords still retain their ambiguity and will result in precision accuracy being in detriment to recall. United States Patent Application 2003/0014403 (Chandrasekar et al) relates to a system and method for query refinement to enable improved searching based on identifying and utilising popular concepts related to users' queries. In one method disclosed therein, a query is received from a user, and then mapped to one or more search concepts. A list of search concepts associated with the query is then displayed. Alternatively or additionally, the search concepts associated with the query are used to provide a set of improved search results. In another method, a number of queries from a number of users are analysed to identify two or more search concepts, and a popularity value is assigned to them based on the queries. Thus, the relative popularity of the respective search concepts can be determined. Alternatively or additionally, a preferred search query for the search concepts can be determined. The popularity and preferred queries can be used to allow automatic or user-initiated refinement.

U.S. Pat. No. 6,453,312 (Goiffon et al) relates to a system and method for developing a selectably-expandable concept-based search. It discloses a computer-implemented system and method for allowing users to interactively develop search queries is provided. The system performs query development utilising a hierarchical concept tree stored in memory, wherein the nodes of the concept tree are concepts that describe various search topics. Parent/child relationships are created between the concepts, with children concepts describing sub-categories of a parent concept, and so on. Any concept at any level in the tree structure may be related to one or more character strings descriptive of the related concept. Query development is performed by traversing the various relationships in the hierarchical tree structure to selectively add related character strings to a potential query.

U.S. Pat. No. 6,246,977 (Messerly et al) relates to information retrieval utilising semantic representation of text and based on constrained expansion of query words. In one embodiment, a “tokenizer” generates from an input string information retrieval tokens that characterise the semantic relationship expressed in the input string. The tokenizer first creates from the input string a primary logical form characterising a semantic relationship between selected words in the input string. The tokenizer then identifies hypemyms that each have an “is a” relationship with one of the selected words in the input string. The tokenizer then constructs from the primary logical form one or more alternative logical forms. The tokenizer constructs each alternative logical form by, for each of one or more of the selected words in the input string, replacing the selected word in the primary logical form with an identified hypernym of the selected word. Finally, the tokenizer generates tokens representing both the primary logical form and the alternative logical forms. The tokenizer is preferably used to generate tokens for both constructing an index representing target documents and processing a query against that index.

### SUMMARY OF THE INVENTION

Embodiments of the present invention aim to improve the precision accuracy of information retrieval systems, particularly where a user submits consecutive queries in a single domain or of related semantic concepts, by automatically and interactively disambiguating keyword senses given by the user.

According to the present invention, there is provided a method of operating an information retrieval system for retrieving information from a database in response to queries submitted by a user, said method comprising the steps of:
receiving a first user query;
deriving a first lexical chain set from said first user query using a predetermined lexical chaining algorithm, said first lexical chain set comprising one or more lexical chains representing possible interpretations of said first user query;
storing one or more lexical chains from said first lexical chain set in a lexical chain storage means;
identifying a first subset of documents from said database using said first lexical chain set and a predetermined information retrieval algorithm;
making information relating to said first subset of documents available to the user;
receiving a subsequent user query, said subsequent user query being related to said first user query;
deriving a subsequent lexical chain set from said subsequent user query using a predetermined lexical chaining algorithm in conjunction with one or more lexical chains stored in said lexical chain storage means;
identifying a subsequent subset of documents from said database using said subsequent lexical chain set and a predetermined information retrieval algorithm;
making information relating to said subsequent subset of documents available to the user. Also according to the present invention, there is provided an information retrieval system for retrieving information from a database in response to queries submitted by a user, said system comprising:
means for receiving a first user query;
means arranged to derive a first lexical chain set from a first user query using a predetermined lexical chaining algorithm, said first lexical chain set comprising one or more lexical chains representing possible interpretations of said first user query;
means arranged to store one or more lexical chains from said first lexical chain set in a lexical chain storage means;
means arranged to identify a first subset of documents from said database using said first lexical chain set and a predetermined information retrieval algorithm;
means for making information relating to said first subset of documents available to the user;
means for receiving a subsequent user query, said subsequent user query being related to said first user query;
means arranged to derive a subsequent lexical chain set from said subsequent user query using a predetermined lexical chaining algorithm in conjunction with one or more lexical chains stored in said lexical chain storage means;
means arranged to identify a subsequent subset of documents from said database using said subsequent lexical chain set and a predetermined information retrieval algorithm;
means for making information relating to said subsequent subset of documents available to the user.

Embodiments of the invention may utilise existing techniques of Lexical Chaining (such as described earlier) and apply them to information and document retrieval. An information retrieval engine can use an index of semantic concepts (i.e. lexical chains), rather than stemmed, selected words. Each query by the user may result in the derivation of a set of lexical chains and it may be the strongest (according to a chosen ranking method) that becomes the query to be processed by an information retrieval engine. These Lexical Chains may be retained in memory and each subsequent query on related concepts may contribute to the chains. Retrieved documents selected by the user as being of relevance can then also be used to contribute to the Lexical Chains. Each interaction of the user with the system may further disambiguate the keyword senses employed by the user and thus improve precision accuracy (i.e. the proportion of documents retrieved that are relevant). A key advantage of embodiments of the invention is that in the case where a user makes more than one related query, information may be built up that helps to disambiguate the user's next query, using the technique of Lexical Chaining.

### BREIF DESCRIPTION OF THE DRAWINGS

FIG. 1 is a flow-chart representing the submission of search queries via a traditional search engine;

FIG. 2 is a flow-chart representing a way of combining related search queries using a traditional search engine;

FIG. 3 is a flow-chart representing in simplified form the submission and processing of related search queries using Lexical Chains according to an embodiment of the present invention;

FIG. 4 is a flow-chart illustrating in more detail the submission and processing of related search queries using Lexical Chains according to an embodiment of the present invention.

### DESCRIPTION OF THE EMBODIMENTS

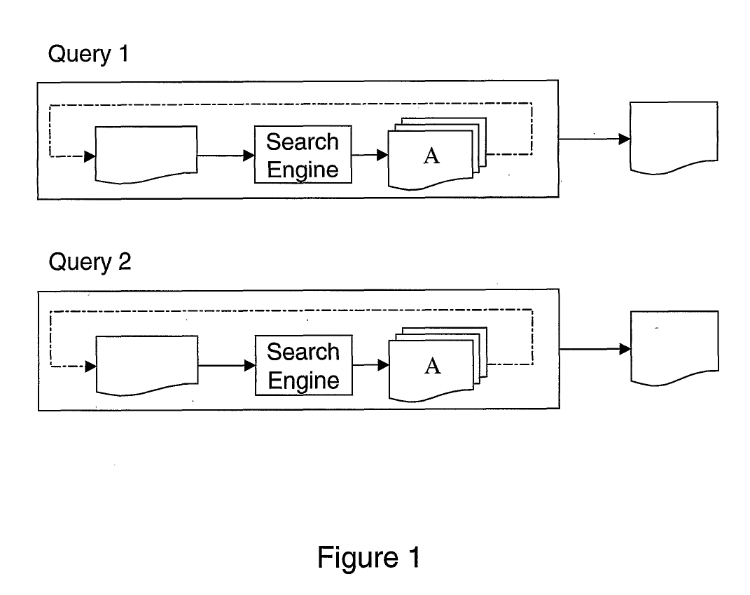

With reference to FIG. 1, when submitting a query via a traditional search engine, a user inputs a query made up of a keyword or a string of keywords. The search engine takes the user's query and extracts the keywords, for example by ignoring “stop words” such as ‘and’, ‘the’ etc., and may also apply a stemming algorithm to bring the remaining words into a canonical form. The keywords are then used as part of a document retrieval algorithm that is applied to a database of documents where keywords map onto the documents, the results of which are displayed to the user.

The first query is thus used to return a subset of all of the documents in the database. The user then has the option of submitting an additional query. The simplest option for the user, when submitting an additional query via a traditional search engine, is for the additional query to be treated separately, and in exactly the same way as the first query. It is then up to the user to consider the results of the second search separately. This effectively takes a different intersection of the whole database with each subsequent query. With this approach the user hopes to find the document they are interested in after a few queries, but there is no guarantee that any particular subsequent query will provide better results than the first query. Once the user finds the required document, or decides to abandon the search, they can then begin a new query and no information is carried over—the user will be searching for a document from scratch.

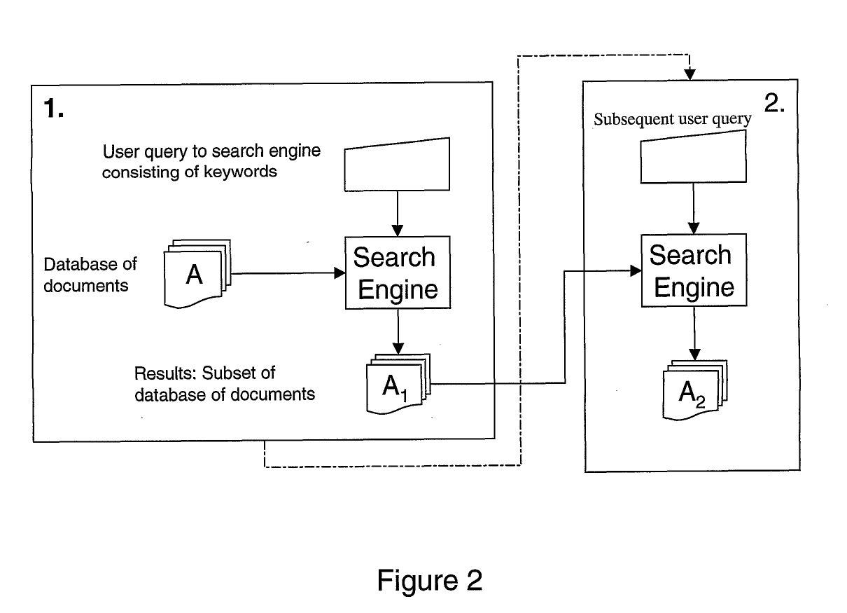

Even with a fairly simple search engine, the user may have slightly more advanced ways of refining the first query by inputting a subsequent query. With reference to FIG. 2, a slightly more advanced option is depicted. According to this, the user may specify that the keywords of the subsequent query should only be mapped onto the subset of documents found as results of the previous query, or an earlier search query. This query is processed in the same manner as before except that one of the following conditions may be applied:
a) the search algorithm is only applied in respect of the subset of documents that were returned in relation to the first query, rather than to the complete database; or
b) the original query keywords are included with the keywords of the current query.

Depending on the search algorithms used, these may or may not lead to the same results. Either way, these techniques effectively provide more and more keywords in the hope that the search ‘homes in’ on the document desired.

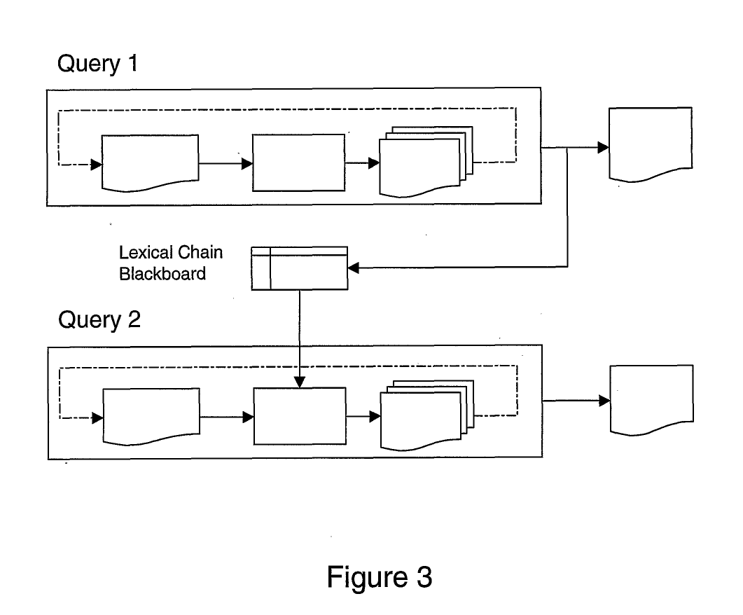

Referring now to FIG. 3, the flow-chart shows in simplified form the submission of related search queries using Lexical Chains according to an embodiment of the present invention, in order to highlight how this differs from the prior art described above. Such embodiments aim to improve the precision accuracy of information retrieval systems, in particular where a user submits consecutive queries in a single domain or of related semantic concepts, by disambiguating keyword senses given by the user. The disambiguation may be done fully automatically, or may be achieved interactively, with the co-operation of the user. According to the embodiment, the search engine receives the user's first query (“Query 1”) and using a chosen Lexical Chaining algorithm, derives from it a set of mutually exclusive lexical chains, which represent different possible interpretations of the user's query. The chosen Lexical Chaining algorithm may be of a known type, such as that proposed by Barzilay (see earlier), or may be specifically created for the embodiment. Any possible ambiguity in the user's query will be reflected in the set having more than member. Prior to the first query of a session, or to the first of a series of related queries, a temporary storage area of memory, which will be referred to as the Lexical Chain blackboard, should be empty. The lexical chains derived in respect of the user's initial query are added to the Lexical Chain blackboard. The search engine uses a search algorithm to map these lexical chains onto a database of documents, and a set of documents which “match” according to certain criteria are returned. A variety of search algorithms may be used, but a preferred algorithm for the purposes of this embodiment of the invention is one which allows documents themselves indexed according to semantic concepts, using lexical chains for example, or meta-data relating to such documents, to be searched with reference to such semantic concepts. The documents identified according to the chosen algorithm or criteria, or reference information relating to such documents, may then be presented as “results” to the user, and the lexical chains representing the returned documents may then be automatically merged with those already present on the blackboard. This process of merging the lexical chains increases the outcome of a scoring function for each mutually exclusive set. In other words, the merging assists in disambiguating the lexical chains present on the blackboard. As explained above, an algorithm based on, or similar to, the Barzilay algorithm referred to above is particularly suitable for this because it allows multiple hypotheses to be maintained that can be updated progressively.

An optional intermediate step, which will be referred in more detail later, allows the user to indicate which of the returned documents are actually considered to be relevant to the original query, and the lexical chains relating only to such documents, rather than those relating to all the returned documents, may be added to the blackboard.

The user can then submit another query (“Query 2” in FIG. 3). The lexical chain blackboard is applied this time and the query to the search engine comprises the user's lexical chains from the query weighted by those on the blackboard. This process can then be repeated.

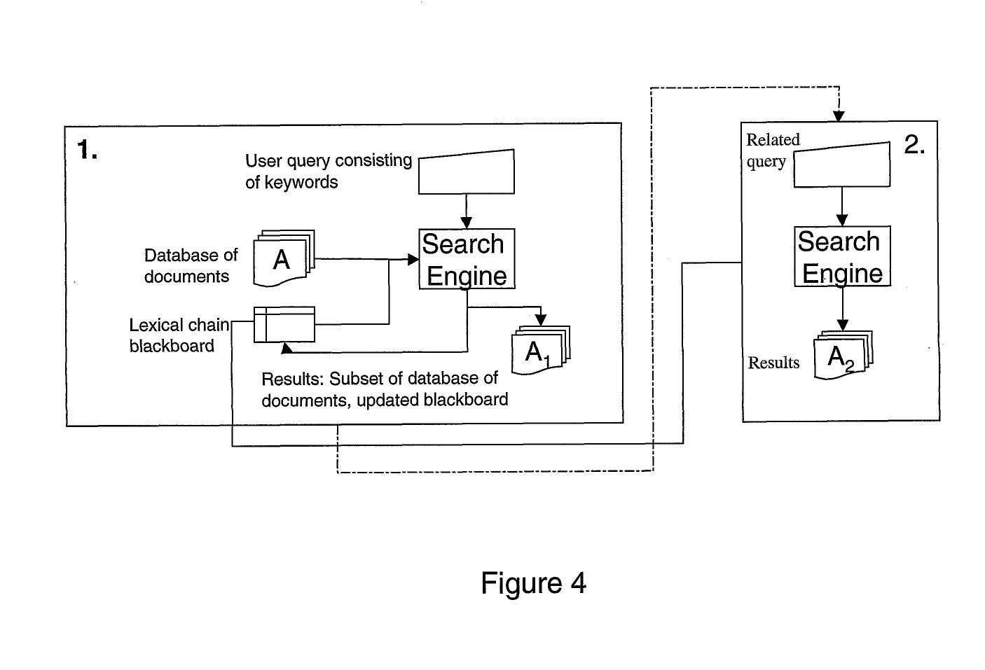

With reference to FIG. 4, the following section outlines the above process in more detail. The first step, which may happen prior to the receipt of any search queries, is to derive an initial index of the concepts described in the documents and information sources from which results will be retrieved in response to the user's queries. The concepts may be automatically derived through the use of Lexical Chaining algorithms, such as the multiple, non-greedy algorithm proposed by Barzilay, outlined above. The process is described with reference to the notion of a user ‘session’—that is, a series of queries to the system from a single user regarding a set of related concepts. Such queries may be automatically deemed to be related on the grounds that they are submitted consecutively, or within an established time-period, or the user may be asked to indicate whether subsequent queries should be taken to be related or not. Step 2 establishes the start of a new ‘user session’, by whatever criteria are chosen to define this. Within a user session, each interaction between the user and the system leads to Lexical Chain hypotheses being created and the highest scoring hypothesis within each interaction forming the query terms for the information retrieval engine (Steps 3-5). Interactions can be follow-up queries or confirmation that a retrieved document is appropriate to the concepts intended by the user.

The process is described in more detail, step-by-step, below:
Step 1. Derive Lexical Chains for each document to be included in the index by using an algorithm such as the one proposed by Barzilay (see earlier). Select the highest scoring set of Lexical Chains for each document and store in a standard information retrieval index.
Step 2. Create a blank area of memory within which mutually exclusive Lexical Chain hypotheses can be stored. We shall call this the Lexical Chain Blackboard, and it is unique within a single session (set of interactions between a single user and the system, and covering a single domain or set of related concepts). Sessions may be determined by a combination of factors, such as user interaction, background identification and application of appropriate user interface.
Step 3. Use a suitable Lexical Chain algorithm to generate Lexical Chains given a combination of the user's query and the existing Lexical Chain Blackboard. This would preferably employ a multiple-hypothesis lexical chaining algorithm (as in Step 1) to the concepts using any Lexical Chain hypotheses that exist on the Lexical Chain Blackboard.
Step 4. Select highest scoring set of Lexical Chains from the Lexical Chain Blackboard using a method similar to, or the same as that in Step 1. Each chain is a set of words that relate to the same concept. This concept or set of concepts forms the query of the information retrieval system. The information retrieval system may use standard retrieval ranking methods (for example, TFxIDF) that uses the index created in Step 1. The documents that have a ranking above a certain threshold may be presented to the user.
Step 5a. The documents that are retrieved are applied to the current Lexical Chain Blackboard using a suitable Lexical Chain algorithm in order to update the Lexical Chain Blackboard. If the user continues the session by providing an additional query, then Steps 3 onwards are repeated in respect of the additional query.
Step 5b. [optional] Instead of applying all of the documents that are retrieved to the current Lexical Chain Blackboard, the user may be given the opportunity to indicate a subset of documents (i.e. those which the user considers to be relevant). This allows for a quicker convergence towards the most probable hypothesis, by applying only these relevant documents, using a suitable Lexical Chain algorithm as per step 5a. Again, if the user continues the session by providing an additional query, then Steps 3 onwards are repeated in respect of the additional query.

1. A method of operating an information retrieval system for retrieving information from a database in response to queries submitted by a user, said method comprising the steps of:
receiving a first user query;
deriving a first lexical chain set from said first user query using a predetermined lexical chaining algorithm, said first lexical chain set comprising one or more lexical chains representing possible interpretations of said first user query;
storing one or more lexical chains from said first lexical chain set in a lexical chain storage means;
identifying a first subset of documents from said database using said first lexical chain set and a predetermined information retrieval algorithm;
making information relating to said first subset of documents available to the user;
receiving a subsequent user query, said subsequent user query being related to said first user query;
deriving a subsequent lexical chain set from said subsequent user query using a predetermined lexical chaining algorithm in conjunction with one or more lexical chains stored in said lexical chain storage means;
identifying a subsequent subset of documents from said database using said subsequent lexical chain set and a predetermined information retrieval algorithm;
making information relating to said subsequent subset of documents available to the user.

2. A method according to claim 1, further comprising additional steps, following the identification of a subset of documents from said database, of:
deriving a lexical chain set from said subset of documents; and
updating said lexical chain storage means in view of said lexical chain set derived from said subset of documents.

3. A method according to claim 1, further comprising the additional steps, following one or more steps of making information relating to a subset of documents available to the user, of:
receiving an indication from a user as to which documents from said subset of documents are considered to be relevant;
deriving a lexical chain set from those documents which are considered to be relevant; and
updating said lexical chain storage means in view of said lexical chain set derived from said documents which are considered to be relevant.

4. A method according to claim 1, further comprising the step of receiving an indication from a user as to whether a subsequent user query is considered to be related to a previous user query or not.

5. A method according to claim 4, wherein said steps of receiving a subsequent user query, deriving a subsequent lexical chain set, identifying a subsequent subset of documents and making information relating to said subsequent subset of documents available to the user are repeated in the event that an indication is received from a user that a subsequent user query is considered to be related to a previous user query.

6. A method according to claim 4, wherein said steps of receiving a subsequent user query, deriving a subsequent lexical chain set, identifying a subsequent subset of documents and making information relating to said subsequent subset of documents available to the user are repeated in the event that no indication is received from a user that a further user query is considered not to be related to a previous user query.

7. A method according to claim 1, wherein the database comprises meta-data relating to said information.

8. A method according to claim 1, wherein the information in the database is indexed using lexical chains.

9. A method according to claim 8, wherein the predetermined information retrieval algorithm is arranged to identify documents with reference to said indexed information.

10. An information retrieval system for retrieving information from a database in response to queries submitted by a user, said system comprising:
means for receiving a first user query;
means arranged to derive a first lexical chain set from a first user query using a predetermined lexical chaining algorithm, said first lexical chain set comprising one or more lexical chains representing possible interpretations of said first user query;
means arranged to store one or more lexical chains from said first lexical chain set in a lexical chain storage means;
means arranged to identify a first subset of documents from said database using said first lexical chain set and a predetermined information retrieval algorithm;
means for making information relating to said first subset of documents available to the user;
means for receiving a subsequent user query, said subsequent user query being related to said first user query;
means arranged to derive a subsequent lexical chain set from said subsequent user query using a predetermined lexical chaining algorithm in conjunction with one or more lexical chains stored in said lexical chain storage means;
means arranged to identify a subsequent subset of documents from said database using said subsequent lexical chain set and a predetermined information retrieval algorithm;
means for making information relating to said subsequent subset of documents available to the user.

11. An information retrieval system according to claim 10, further comprising:
means for deriving a lexical chain set from an identified subset of documents; and
means for updating said lexical chain storage means in view of said lexical chain set derived from said subset of documents.

12. An information retrieval system according to claim 10, further comprising:
means for receiving an indication from a user as to which documents from an identified subset of documents are considered to be relevant;
means for deriving a lexical chain set from those documents which are considered to be relevant; and
means for updating said lexical chain storage means in view of said lexical chain set derived from said documents which are considered to be relevant.

13. An information retrieval system according to claim 10, further comprising means for receiving an indication from a user as to whether a subsequent user query is considered to be related to a previous user query or not.

14. An information retrieval system according to claim 10, wherein the database comprises meta-data relating to said information.

15. An information retrieval system according to claim 10, wherein the information in the database is indexed using lexical chains.

16. An information retrieval system according to claim 15, wherein the predetermined information retrieval algorithm is arranged to identify documents with reference to said indexed information.
